(19) United States
(12) Patent Application Publication
(10) Pub. No.: US 2019/0296299 A1
(43) Pub. Date: Sep. 26, 2019

(54) CELL TERMINAL FOR VEHICLE BATTERY PACK

(71) Applicant: Voltabox AG, Delbrueck (DE)

(72) Inventors: Jochen Stichling, Beckum (DE); Constantin Werth, Paderborn-Wewer (DE)

(21) Appl. No.: 16/359,529

(22) Filed: Mar. 20, 2019

(30) Foreign Application Priority Data
Mar. 21, 2018 (DE) 102018002333.9

(51) Int. Cl. H01M 2/10; H01M 2/20; H01M 2/30

(52) U.S. Cl. CPC H01M 2/1083; H01M 2/305; H01M 2/206

(57) ABSTRACT

A cell terminal for connecting cells to form a vehicle battery pack has an inner end connected to a pole of one of the cells and an outer end spaced from the and connectable integrally to a pole of another of the cells. The inner and outer ends are generally planar and extend generally at a right angle to each other. An elastically deformable U-shaped bight web connected unitarily between the inner and outer ends permits relative movement of the cells without disconnection.

### FIELD OF THE INVENTION

The present invention relates to a vehicle battery pack. More particularly this invention concerns a cell terminal for such a pack.

### BACKGROUND OF THE INVENTION

A motor-vehicle battery pack is formed by a plurality of battery assemblies each having a cell with terminals extending from the poles of the cells. A frame may surround the cell. A stack of such cells forms the pack and the terminals of the cells are connected to one another to gang the cells.

Thus each terminal has an inner end fixed to the respective pole of the respective cell, and an outer end that is connected to a terminal of the adjacent cells. The outer end is intended to be integrally connected to an adjacent terminal, for instance by weld, and to this end is bent to lie in a normally horizontal plane perpendicular to the normally vertical plane in which the cell and the inner terminal end lie.

Cell terminals of this type or the integral connection, by which they are connected at the terminal of the vehicle battery cell to connecting elements used for adjacent cells of a vehicle battery pack, are exposed to loads due to vibrations, which may lead to tearing or tearing off of the cell terminals at their connecting points as the cells move limitedly relative to each other.

### OBJECTS OF THE INVENTION

It is therefore an object of the present invention to provide an improved cell terminal for a vehicle battery pack.

Another object is the provision of such an improved cell terminal for a vehicle battery pack that overcomes the above-given disadvantages, in particular that permits the formation of a durable and operationally reliable integral connection to adjacent terminals.

A further object is to provide such a cell terminal that even makes it be possible to compensate for transverse loads acting on the integral connection and to prevent tearing or tearing off of the cell terminals due to work hardening.

### SUMMARY OF THE INVENTION

A cell terminal for connecting cells to form a vehicle battery pack. The cell terminal having an inner end connected to a pole of one of the cells, an outer end spaced from the and connectable integrally to a pole of another of the cells. The inner and outer ends are generally planar and extending generally at a right angle to each other, and an elastically deformable U-shaped bight or relief web connected unitarily between the inner and outer ends permitting relative movement of the cells without disconnection.

In other words, the cell terminal has a relief web integral with both ends between its inner terminal end and its outer terminal end and the relief web and the two ends of the cell terminal are constructed such that they are offset or movable with respect to one another. Vibrations that trigger the loads mentioned are absorbed and cushioned by elastic deformation of the relief web according to the invention. They have no or virtually no effect on the material connection formed between the outer terminal end of the cell terminal on one side and the connecting element fixed to the cell terminal and securely located in a vehicle-battery-cell-side mount on the other side. this integral connection, as already mentioned, may advantageously be a weld seam. The relief web makes it possible for the two ends to be offset or moved with respect to one another, without this having perceptible effects on the integral connection between the outer terminal end of the cell terminal and the connecting element.

According to an advantageous development of the cell terminal according to the invention, the bight or relief web thereof has a leg or extension merging with of the inner terminal end, a bight web extending from the extension, and a planar other leg extending from the other side of the bight web, and a bend that secures the other leg with the outer terminal end. A relief web configured in this manner, can compensate for vibrations and comparable loads to a high degree, and prevent that these vibrations or loads have perceptible effects on the integral connection between the cell terminal and the connecting element.

Advantageously, in the case of the relief web of the cell terminal according to the invention, the curvature of the bend is opposite that of the bight web.

According to an advantageous development of the relief web of the cell terminal according to the invention, the curvature of the first bight web is greater than 90° and less than 180°.

Advantageously, the amount of curvature of the bend then approximately corresponds to the amount of the curvature of the first bight web in excess of 90°. As a result, a design of the relief web of the cell terminal according to the invention associated with a comparatively low space requirement can be realized.

According to an advantageous embodiment of the cell terminal according to the invention, the amount of the curvature of the bend runs to about 60 to 80, preferably to 70°.

### BRIEF DESCRIPTION OF THE DRAWING

The above and other objects, features, and advantages will become more readily apparent from the following description, reference being made to the accompanying drawing in which:

FIG. 1 is a schematic perspective view of a portion of a vehicle battery cell according to the invention;

FIG. 2 is an enlarged view of a detail of FIG. 1; and

FIG. 3 is a schematic view of a plurality of joined cells of a vehicle battery pack.

### SPECIFIC DESCRIPTION OF THE INVENTION

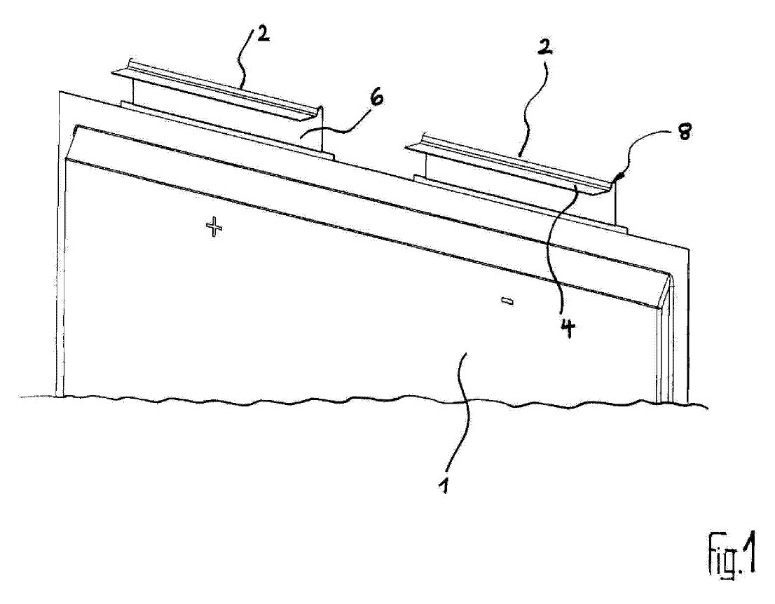

As seen in FIGS. 1-3 a vehicle battery cell 1 has two cell terminals 2 of which one is fixed to a minus pole and one to a plus pole of the vehicle battery cell 1. The cell terminals 2 of the vehicle battery cell 1 can be connected to adjacent cells to form a vehicle battery pack with each cell lying adjacent further such cells in respective vertical and parallel planes.

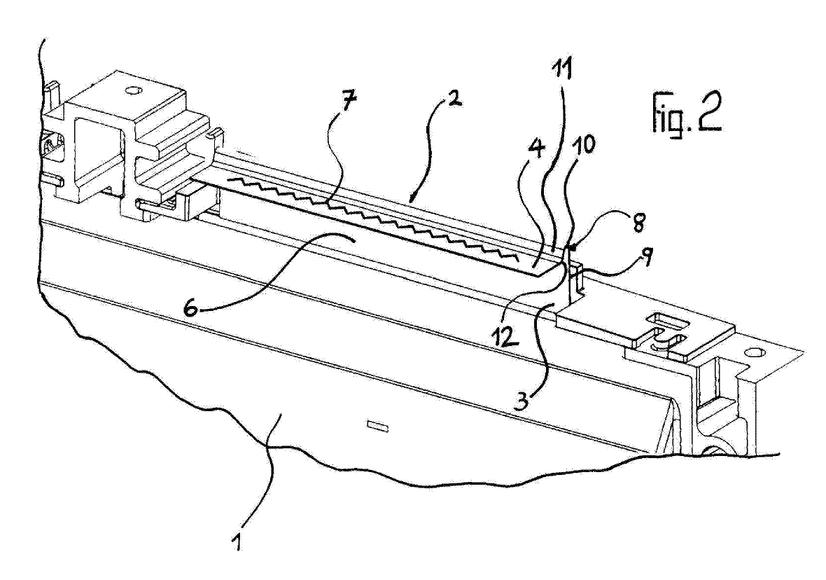

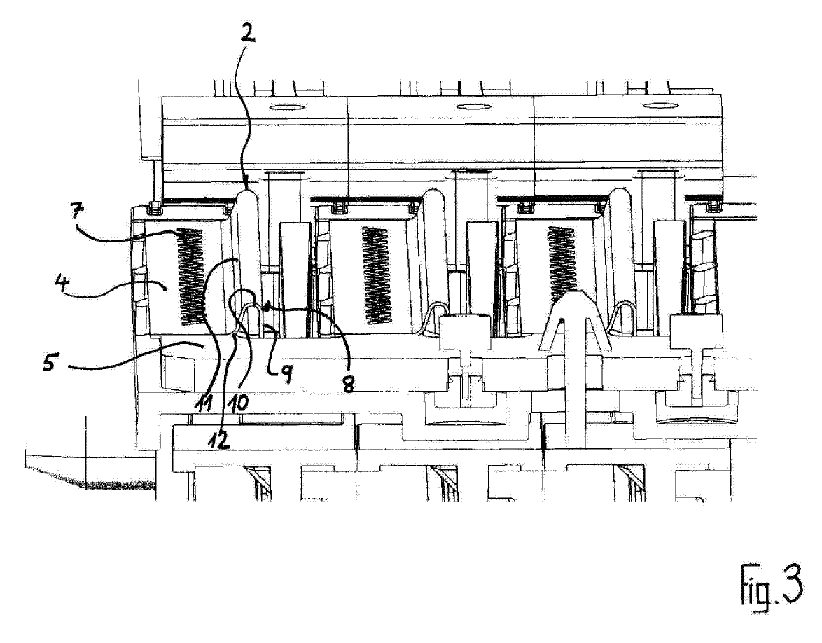

The cell terminal 2 has an inner terminal end 3 that is connected to the respective pole of the respective cell 1 and has an outer terminal end 4 that can be connected to an adjacent vehicle battery cell 1, as seen in FIG. 3. A connecting element 5 formed of copper extends between adjacent cells of a vehicle battery pack 1 as shown in FIG. 3 and can be slid into a space 6 underneath the outer terminal end 4 of the cell 1. Lateral extensions of the connecting element 5 extend into the space 6 illustrated clearly in FIG. 2, as is illustrated in FIG. 3. This space 6 is formed by the cell terminal 2 shown in FIG. 2, of the vehicle battery cell 1, and the extensions of the connecting element 5 can be slid into it.

For securely attaching the lateral extensions of the connecting element 5 to the cell terminal 2, an integral connection is provided between the outer end 4 of the cell terminal 2 on the one hand and connecting element 5 on the other hand, which integral connection is formed, in the case of the embodiment of the cell terminal 2 shown in FIGS. 1 to 3, by a weld seam 7.

For a durable and operationally reliable design of the weld seam 7 between the cell terminal 2 and the connecting element 5, an elastically deformable relief web 8 is formed unitarily between the inner terminal end 3 and the outer terminal end 4 of the cell terminal 2. The relief web 8 is made unitarily of the same copper-alloy sheet metal as both the inner terminal end 3 and the outer terminal end 4 of the cell terminal 2.

FIGS. 1 to 3 show that the outer terminal end 4 of the cell terminal 2 extends approximately at a right angle to the respective inner terminal end 3.

Even under the transverse loads acting on the connection between the cell terminal 2 and the connecting element 5, the relief web 8 allows the necessary play or the necessary compensation in order to protect the weld seam 7 and to prevent tearing or tearing out of the cell terminals 2 due to work hardening.

To this end, the relief web 8 in the embodiment shown in FIGS. 1 to 3. It has one leg merging into a normally vertical planar extension 9 that in turn merges into the inner terminal end 3 of the cell terminal 2 so as to be coplanar therewith. A first downwardly open U-shaped bight web 10 whose curvature is about 110° in the embodiment illustrated in FIGS. 1 to 3 extends from the extension section 9 at the upper end thereof turned away from the vehicle battery cell 1. Another planar leg or section 11 merges into a bend 12 connecting the section 11 of the relief web 8 to the planar end 4 at the end thereof facing away from the vehicle battery cell 1 and joins the bight web 10 of the relief web 8 to the end 4. Thus the U-shaped bight 10 has one leg or extension 9 extending and merging with the planar inner end 3 and an opposite planar leg connected via the bend 12 to the outer end 4.

In the illustrated embodiment, the curvature of the bend 12 of the relief web 8 opposes that of the first bight web 10 and is about 70°. This results in an approximately right-angled arrangement of the outer end 4 relative to the inner end 3 of the cell terminal 2.

The connecting element 5 has lateral extensions that can be inserted or pushed into the mounting space 6 formed below the outer terminal end 4 of the cell terminal 2. If the lateral extension of the connection element 5 associated with the cell terminal 2 is below the outer terminal end 4 of the cell terminal 2, the integral connection or the weld seam 7 can be created in a simple manner to form a fixed connection between the cell terminal 2 on the one hand and the connecting element 5 on the other hand.

We claim:

1. A cell terminal for connecting cells to form a vehicle battery pack, the cell terminal having:
an inner end connected to a pole of one of the cells;
an outer end spaced from the and connectable integrally to a pole of another of the cells, the inner and outer ends being generally planar and extending generally at a right angle to each other; and
an elastically deformable U-shaped bight web connected unitarily between the inner and outer ends and permitting relative movement of the cells without disconnection.

2. The cell terminal defined in claim 1, wherein the U-shaped bight web has an inner leg unitarily merging with the inner end an outer leg unitarily merging via a bend with the outer end.

3. The cell terminal defined in claim 2, wherein each of the legs is planar.

4. The cell terminal defined in claim wherein the inner leg is coplanar with the inner end.

5. The cell terminal defined in claim 2, wherein a curvature of the bend is opposite to a curvature of the U-shaped bight web.

6. The cell terminal defined in claim 5, wherein the bight web has a curvature between the inner and outer legs of between 90° and 180°.

7. The cell terminal defined in claim 6, wherein the bend extends through an arc having an angular length equal to 180° minus the curvature of the bight web.

8. The cell terminal defined in claim 7 wherein the bend has a curvature of 60° to 80°.

9. The cell terminal defined in claim 5, wherein the angular curvature of the bend and of the bight web are equal to 890° such that the outer end extends at 90° to the inner end.

10. In combination with a vehicle battery pack having a plurality of adjacent cells, a cell terminal at each of the cells and having:
an inner end connected to a pole of one of the cells;
an outer end spaced from the and connectable integrally to a pole of another of the cells, the inner and outer ends being generally planar and extending generally at a right angle to each other; and
an elastically deformable U-shaped bight web connected unitarily between the inner and outer ends and permitting relative movement of the cells without disconnection.

11. The combination defined in claim 10, further comprising:
a connecting element extending between the cells and fixedly connected to the outer end of each cell terminal.
